(19) United States
(12) Patent Application Publication
(10) Pub. No.: US 2007/0208281 A1
(43) Pub. Date: Sep. 6, 2007

(54) PROCESS AND APPARATUS FOR SOFT TISSUE MANIPULATION

(76) Inventor: Ronald J. Brooks, Thousand Oaks, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/682,430

(22) Filed: Mar. 6, 2007

Related U.S. Application Data
(60) Provisional application No. 60/767,135, filed on Mar. 6, 2006.

(51) Int. Cl. A61H 7/00; A61H 1/00

(52) U.S. Cl. 601/6; 601/15

(57) ABSTRACT

A vacuum pump apparatus for neurovascular restructuring of soft tissue includes at least two vacuum pumps connected to separate vacuum suction cups. The vacuum pumps are independently adjustable to a certain level of vacuum, as well as, hold time and release time. The vacuum suction cups are applied to areas of soft tissue that have suffered trauma or are otherwise causing pain. The vacuum action acts to lift and separate fascia and muscle tissue to allow for proper blood flow and alleviation of compression on nerve bundles.

### BACKGROUND OF THE INVENTION

The present invention generally relates to an apparatus and process to manipulate soft tissue for the purpose of alleviating pain and/or discomfort. More particularly, the present invention relates to a suction device and method of use to manipulate fascia and muscle tissue to improve blood flow and alleviate trauma to nerve bundles.

Cupping devices for stimulating the skin, muscles, nerves and blood circulation are known in the art. In general, these devices operate on the principle of vacuum. Specifically, such devices act as a counter-irritant; as is proven by the pain attending the operation, and by the increase of action it excites in the vessels of the tissue and to some distance around. The action of these devices has proven to only succeed in temporarily relieving pain or discomfort.

Accordingly, there is a need for an apparatus and method to assist in the manipulation of soft tissue, with specificity to the structure and damage of the superficial tissues, to alleviate pain and/or discomfort, which provides long term relief without producing significant discomfort during application of the device. The present invention satisfies these needs and provides other related advantages.

### SUMMARY OF THE INVENTION

The present invention is directed to a process for treating soft tissue trauma comprising the steps of applying heat, cold, electrical stimulation and/or a vasopump to injured soft tissue and utilizing a vacuum pump to mobilize the injured soft tissue by neurovascular restructuring. The process begins with the preliminary step of taking a detailed patient history focusing on disorders of neurovascular components, trauma, skeletal defects, medications, mental and emotional states, or a physical examination of the soft tissue trauma. The vacuum utilizing step includes the step of applying first and second vacuum cups to the injured soft tissue.

Before neurovascular restructuring can begin, a practitioner must first reduce excess fluid in the injured soft tissue. The step of reducing excess fluid includes drawing the excess fluid away from the injured soft tissue. Once the excess fluid is reduced, the soft tissue is palpated to examine the trauma.

The soft tissue is restructured by performing multiple treatments using the vacuum pump apparatus. As the treatments advance, the first and second vacuum cups become smaller and vacuum pressure increases. In addition, a practitioner may use vacuum cups having center posts. Neurovascular restructuring involves lifting and separating layers of injured soft tissue.

A vacuum pump apparatus for treating soft tissue trauma comprises a first vacuum pump having a first vacuum cup associated therewith and a second vacuum pump having a second vacuum cup associated therewith. A first control apparatus monitors and operates the first vacuum pump and a second control apparatus monitors and operates the second vacuum pump. The first and second control apparatuses comprise separate pressure gauges, vacuum pressure control knobs, and operation switches to control whether each respective vacuum pump is on a timer or under continuous vacuum. The control apparatuses also include indicia for indicating whether the respective vacuum pump is ready or a vacuum is being set.

The vacuum pump apparatus also includes means for regulating how long both pumps hold a vacuum and how long both pumps release the vacuum. These means for regulating the duration of vacuum hold and release are adjustable to a value between zero and thirty seconds.

The first and second vacuum cups may vary in size depending upon patient preference and the amount of vacuum pressure to be applied. One or more of the vacuum cups may be a posted vacuum cup containing a center post.

Other features and advantages of the present invention will become apparent from the following more detailed description, taken in connection with the accompanying drawings which illustrate, by way of example, the principles of the present invention.

### BRIEF DESCRIPTION OF THE DRAWINGS

The accompanying drawings illustrate the invention. In such drawings:

FIG. 1 depicts an orthogonal view of the vacuum pump apparatus of the present invention;

FIG. 2 depicts various fascia and muscles in the back of a human being;

FIG. 3 is a cut-away of the fascia and muscles indicated by circle 3 in FIG. 2;

FIG. 4 depicts the fascia and muscles of the human back with the vacuum cups of the apparatus being applied;

FIG. 5 is a cross section of the soft tissue in FIG. 3 indicated by line 5-5 of FIG. 3; and

FIG. 6 depicts the soft tissue of FIG. 5 following application of the vacuum pump apparatus of the present invention.

### DETAILED DESCRIPTION OF THE PREFERRED EMBODIMENT

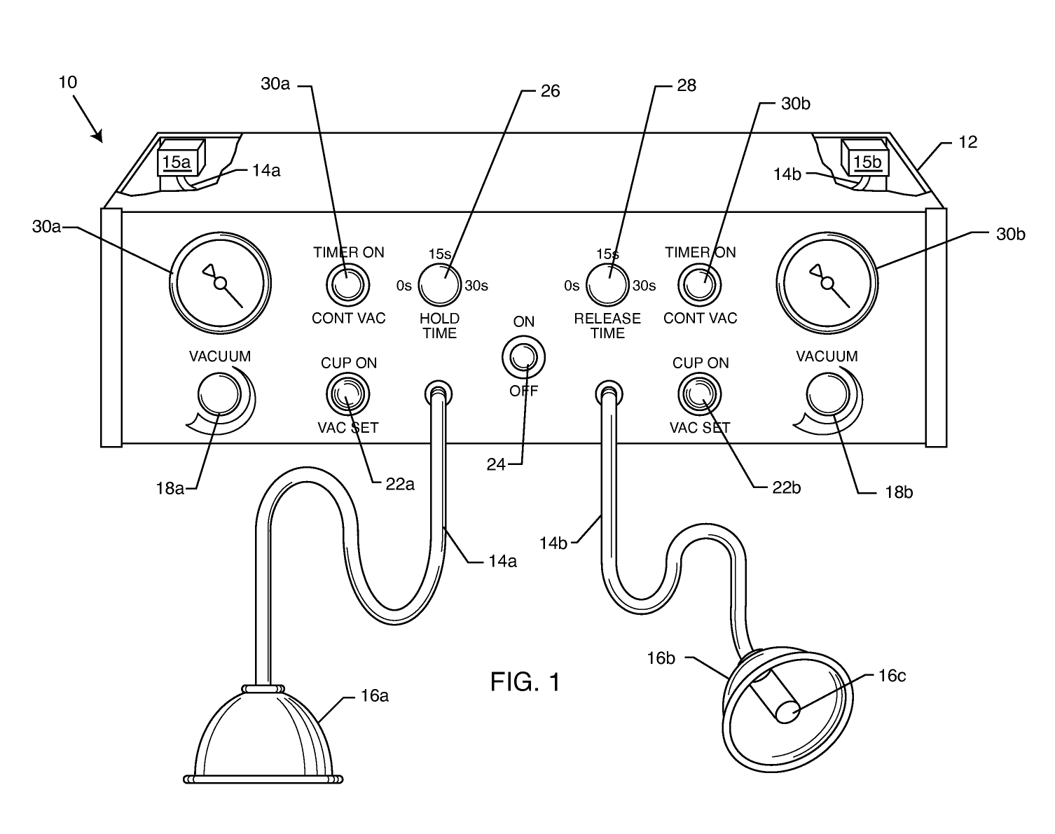

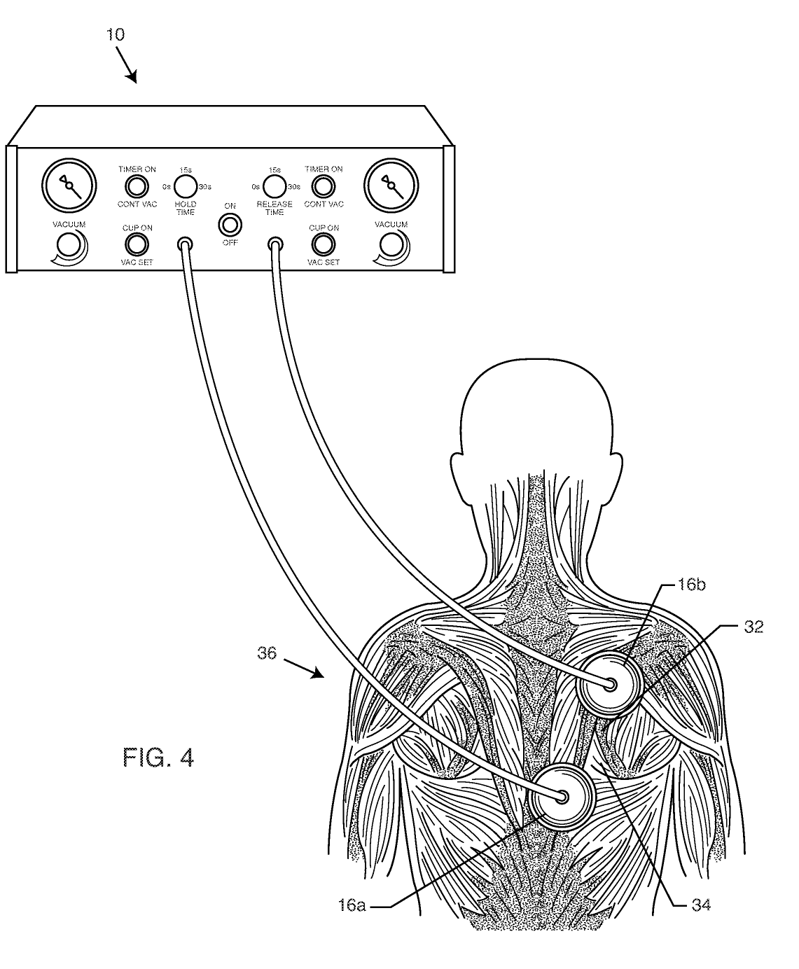

As shown in the drawings for purposes of illustration, a preferred embodiment of the present invention resides in a vacuum pump apparatus 10. As illustrated in FIGS. 1 and 4, the vacuum pump apparatus 10 includes a housing 12, vacuum hoses 14a, 14b and vacuum suction cups 16a, 16b. One or both of these vacuum suction cups 16a, 16b may include a central member 16c making that cup a posted cup. A posted vacuum cup has a central member 16c that extends from the top of the cup to level with the bottom edge of the cup such that it contacts the patient's skin at the same time as the edge of the cup. The cup has openings around the top of the post such that a vacuum is generated in the bell area around the post. Non-posted cups do not include this central member.

Each vacuum hose 14a, 14b is connected to a separate vacuum pump 15a, 15b contained within the housing 12. Each vacuum pump 15a, 15b is connected to a separate vacuum adjustment dial 18a, 18b for regulating the amount of vacuum created by each vacuum pump 15a, 15b. Each vacuum pump 15a, 15b also has a pressure gauge 20a, 20b to display the current vacuum pressure and an indicator light 22a, 22b to indicate whether a vacuum is being created in the suction cups 16a, 16b or the cups 16a, 16b are ready for use. The use of two vacuum pumps 15a, 15b eliminates the possibility of pressure drop if using one vacuum pump for two suction cups.

The vacuum pump apparatus 10 has a single on/off switch 24 which controls both vacuum pumps 15a, 15b. The apparatus 10 also has a single hold time dial 26 and a single release time dial 28, both of which regulate the operation of both pumps 15a, 15b. Each dial 26, 28 is adjustable to a value between zero seconds and thirty seconds. The hold time dial 26 tells the apparatus 10 how long to hold a vacuum in the vacuum suction cups 16a, 16b. The release time dial 28 tells the apparatus 10 how long to leave off a vacuum each time the vacuum is released. Each vacuum pump 15a, 15b has a timer/continuous switch 30a, 30b which tells each vacuum pump whether to hold a continuous vacuum or hold a timed vacuum/timed release according to the settings of the hold time dial 26 and release time dial 28.

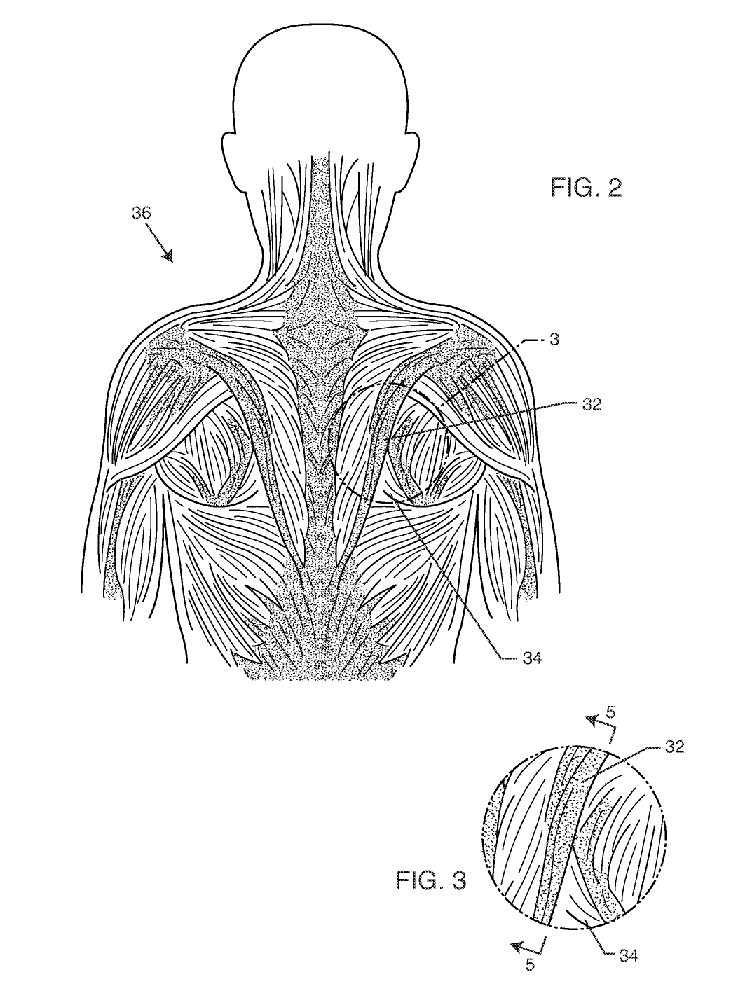

FIGS. 2 and 3 depict fascia 32 and muscle 34 on the back of a human patient 36. FIG. 4 depicts the application of the vacuum suction cups 16a, 16b to an area of the back of the patient 36 to manipulate the fascia 32 and muscle 34. The fascia 32 and muscle 34 depicted in FIGS. 2, 3 and 4 only present one area where the vacuum pump apparatus 10 of the present invention may prove beneficial. The vacuum suction cups 16a, 16b may be placed on other areas of soft tissue on the patient 36 that require manipulation according to the invention.

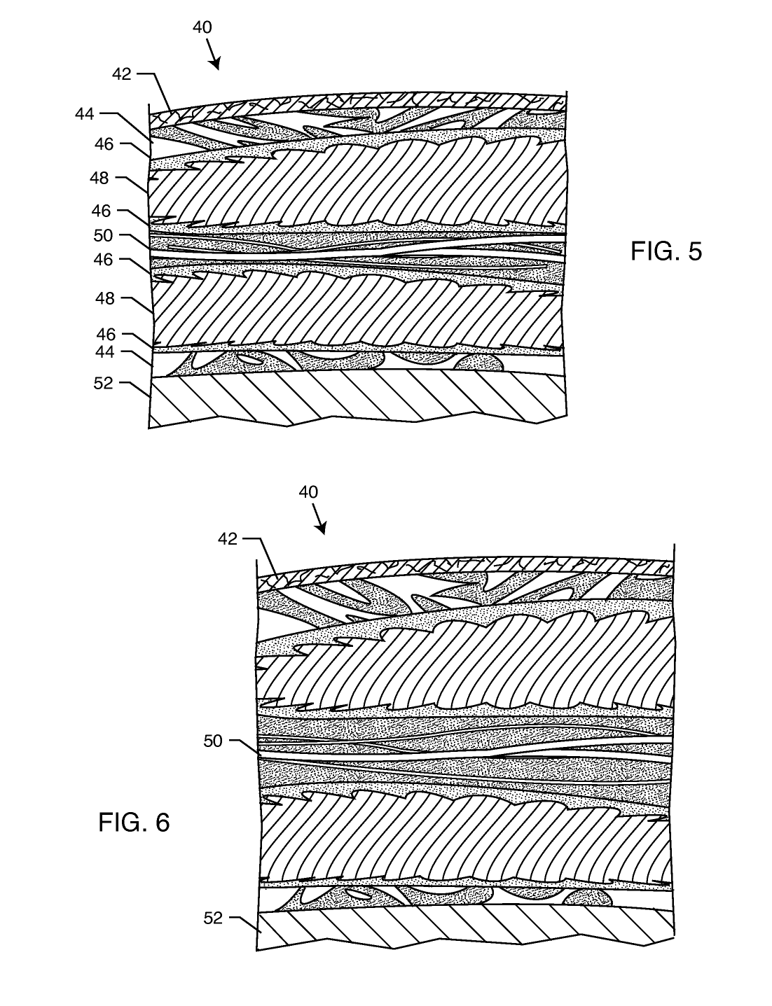

FIG. 5 depicts a region of soft tissue 40 which may receive treatment from the vacuum pump apparatus 10. The layers in this region of soft tissue 40 comprise skin 42, multiple fascia layers 44, multiple muscle-fascia layers 46, multiple muscle layers 48, a fascia layer containing blood vessels and nerves 50 and a bone layer 52. In FIG. 5, the fascia layer containing blood vessels and nerves 50 is compressed binding the blood vessels and nerves together, which can cause pain or discomfort for a patient 36. Such compression and binding may result from muscle tension or trauma to the surrounding tissue resulting in increased fluid retention. As shown in FIG. 6, after one or more applications of the vacuum pump apparatus 10 to the surrounding soft tissue 40, the fascia layer containing blood vessels and nerves 50 is pulled apart to allow for proper blood flow and alleviation of compression on nerve bundles in the treatment area. During treatment, the vacuum suction cups 16a, 16b may be moved around to manipulate the treatment area and redirect blood flow.

The method of treating a patient 36 with the vacuum pump apparatus 10 to achieve neurovascular restructuring begins with an evaluation of the patient 36 including the following: a detailed history that focuses on disorders of neurovascular components; trauma; skeletal defects; medications; personality type (mental and emotional status); and a physical examination focused on palpation over the areas of pain, as well as, any other appropriate tests. The next step involves the preparation of the soft tissue 40 to be treated including the application of heat, cold, electrical stimulation and/or a vasopump. Finally, treatment resulting in soft tissue mobilization utilizing neurovascular restructuring varies depending upon the number of treatments and the area of the soft tissue 40 to be treated.

On the first visit, the size and type of vacuum suction cups 16a, 16b to be used depends upon the location of the soft tissue 40 to be treated and the patient's response to bruising. If the patient is uncomfortable with bruising, it is best to use posted cups with a vacuum pressure of 2 mmHg. This aids in establishing the patient's baseline tolerance for the treatment.

One significant effect of soft tissue trauma is called the “hydraulic effect”. This condition occurs in an area of soft tissue that has been traumatized thereby creating fibrosing of the soft tissues, i.e., nerves, blood vessels, lymph vessels, etc., in the skin and subcutaneous tissue. Skin which has suffered this kind of trauma takes on a thick leathery consistency and the blood vessels are raised up secondary to engorgement. Palpation is key to determining the areas to treat, as well as, the type and size of cup and intensity of vacuum pressure. In areas of pain where the skin has a thick leathery consistency and engorged vascular components, a practitioner may be able to palpate small nerves stretched taut between the vascular components and pain may be elicited from the patient. Higher levels of pain will be experienced where a nerve intersects another nerve.

The first stage of treatment in such an area is to reduce the “hydraulic effect” by using a vacuum pump, if applicable, cold followed by cupping. A practitioner may reduce the hydraulic effect through application of one vacuum cup 16a to draw the excess fluid away from the area to be treated. The treatment area remains free of the excess fluid through the continued application of the vacuum suction cup 16a during palpation and subsequent treatment with the second vacuum suction cup 16b. Once the area is evacuated of fluid, a practitioner can feel the damaged tissues. This type of palpation requires a high level of skill and a great deal of time to develop. The fingertips must become highly sensitized to the different structures in and under the skin. The skills are essential in determining the structure of the damaged tissues so that proper methods of cupping may be applied. Each time a patient returns, the palpation process must be repeated to determine progress and how to proceed for the current session. When the fluid is reduced sufficiently, the practitioner chooses two cups that will work in a particular area. For example, in the hip region, one would most likely choose a 6″ cup non-posted to draw all tissues taut and work in opposition with a 2″ cup posted, to start to pull the fibrosed tissue apart. This may require several attempts to find the weak point of the structure. Once this is determined, the area will begin to soften and will come apart. The application of cups is determined by the size and contour of the body part. Posted cups are primarily used to lift and separate the tissue layers that have fibrosed together.

Restructuring of the soft tissue begins at approximately 2 mmHg vacuum. As above, the application of this pressure depends upon patient's pain tolerance. Gauge measurements of the vacuum are based upon the physics of an absolute vacuum. The use of larger non-posted cups are more favorable for evacuating fluid and are the ones used most often when treatment begins. The size of the affected area and the contour of the body determine the size and shape of the vacuum suctions cups 16a, 16b being used. Posted cups are used to lift and separate tissue levels. The presence of a post in the cup functions as a massager on the skin, as if a masseuse were digging in a thumb or finger. This action aids in removing knots or other obstructions in tissue.

As the number of treatments increase, treatment is adjusted accordingly and the level of vacuum is advanced according to the patient's tolerance. Optimum treatment levels for the various sizes of vacuum suction cups 16a, 16b are as follows:
¾ to 1 inch cups—20 mmHg to 28 mmHg
2 inch cups—15 mmHg to 20 mmHg
6 inch cups—2 mmHg to 15 mmHg

This method of neurovascular restructuring is unique from all other treatments in physical therapy as it lifts and over time separates superficial layers of soft tissue, i.e., skin, blood vessels, lymph vessels and nerves. The systems are restored to a much higher level of function, improving blood flow, immune response, and elasticity and, most importantly, taking pressure off of the nerves. Entrapped nerves produce a type of pain, as in sympathetic reflex dystrophy. When tissue quality improves, the pain abates. The patient must be totally engaged in the treatment as feedback from the patient helps to determine the progression of the treatment plan. In many cases, patients get in touch with their physical body and minds for the very first time in their lives.

Treatment is usually completed by reducing the trauma of cupping with ice, followed by ultrasound. Sometimes medication is introduced into the affected tissues suffering phonophoresis or iontophorisis.

The superficial layers of soft tissue are responsible for a great deal of the pain that patients experience. Pain such as fibromyalga manifest at the superficial level. This is the reason for targeting the superficial nerves, which become trapped in the soft tissue. These superficial nerves become extremely hypersensitive and must be desensitized before moving on to the deeper layers. In many cases, the pain is only at the superficial level and the pain dissipates once that is relieved.

Although an embodiment has been described in detail for purposes of illustration, various modifications may be made without departing from the scope and spirit of the invention.

What is claimed is:

1. A process for treating soft tissue trauma, comprising the steps of: applying heat, cold, electrical stimulation and/or a vasopump to injured soft tissue; and utilizing a vacuum pump to mobilize the injured soft tissue by neurovascular restructuring.

2. The process of claim 1, including the preliminary step of taking a detailed patient history focusing on disorders of neurovascular components, trauma, skeletal defects, medications, mental and emotional states, or physical examination of the soft tissue trauma.

3. The process of claim 1, wherein the vacuum utilizing step includes the step of applying first and second vacuum cups to the injured soft tissue.

4. The process of claim 1, including the step of reducing excess fluid in the injured soft tissue.

5. The process of claim 4, wherein the reducing step includes drawing the excess fluid away from the injured soft tissue.

6. The process of claim 4, including the step of palpating the soft tissue to examine the soft tissue trauma.

7. The process of claim 3, further comprising the step of restructuring the soft tissue by performing multiple treatments utilizing the vacuum pump.

8. The process of claim 7, wherein, as the treatments advance, the first and second vacuum cups become smaller and vacuum pressure increases.

9. The process of claim 1, wherein the neurovascular restructuring includes lifting and separating layers of injured soft tissue.

10. A process for treating soft tissue trauma, comprising the steps of:
applying heat, cold and/or a vasopump to injured soft tissue;
utilizing a vacuum pump to mobilize the injured soft tissue by neurovascular restructuring through the application of first and second vacuum cups; and
reducing excess fluid in the injured soft tissue by drawing the excess fluid away from the injured soft tissue.

11. The process of claim 10, including the step of palpating the soft tissue to examine the soft tissue trauma.

12. The process of claim 10, further comprising the step of restructuring the soft tissue by performing multiple treatments utilizing the vacuum pump, wherein, as the treatments advance, the first and second vacuum cups become smaller and vacuum pressure increases.

13. The process of claim 10, wherein the neurovascular restructuring includes lifting and separating layers of injured soft tissue.

14. The process of claim 10, including the preliminary step of taking a detailed patient history focusing on disorders of neurovascular components, trauma, skeletal defects, medications, mental and emotional states, or physical examination of the soft tissue trauma.

15. A vacuum pump apparatus for treating soft tissue trauma, comprising:
a first vacuum pump having a first vacuum cup associated therewith;
a second vacuum pump having a second vacuum cup associated therewith;
a first control apparatus for monitoring and operating the first vacuum pump; and
a second control apparatus for monitoring and operating the second vacuum pump.

16. The apparatus of claim 15, wherein the first and second control apparatuses comprise separate pressure gauges, vacuum pressure control knobs, and operation switches to control whether each respective vacuum pump is on a timer or under continuous vacuum, and indicia for indicating whether the respective vacuum cup is ready or a vacuum is being set.

17. The apparatus of claim 15, including means for regulating how long both pumps hold a vacuum.

18. The apparatus of claim 17, including means for regulating how long both pumps release the vacuum.

19. The apparatus of claim 18, wherein the means for regulating how long both pumps hold and release the vacuum are adjustable to a value between zero and thirty seconds.

20. The apparatus of claim 15, wherein the first and second vacuum cups vary in size.

21. The apparatus of claim 15, wherein at least one of the vacuum cups is a posted vacuum cup.

22. A vacuum pump apparatus for treating soft tissue trauma, comprising:
a first vacuum pump having a first vacuum cup associated therewith;
a second vacuum pump having a second vacuum cup associated therewith;
a first control apparatus for monitoring and operating the first vacuum pump;
a second control apparatus for monitoring and operating the second vacuum pump;
means for regulating how long both pumps hold a vacuum; and
means for regulating how long both pumps release the vacuum.

23. The apparatus of claim 22, wherein the first and second control apparatuses comprise separate pressure gauges, vacuum pressure control knobs, and operate switches to control whether each respective vacuum pump is on a timer or under continuous vacuum, and indicia for indicating whether the respective vacuum cup is ready or a vacuum is being set.

24. The apparatus of claim 22, wherein the means for regulating how long both pumps hold and release the vacuum are adjustable to a range between zero and thirty seconds.

25. The apparatus of claim 24, wherein the first and second vacuum cups vary in size and at least one of the vacuum cups is a posted vacuum cup.
